(19) United States
(12) Patent Application Publication
(10) Pub. No.: US 2023/0362158 A1
(43) Pub. Date: Nov. 9, 2023

(54) INFORMATION PROCESSING APPARATUS, AUTHENTICATOR, METHOD THEREFOR, AND STORAGE MEDIUM

(71) Applicant: CANON KABUSHIKI KAISHA, Tokyo (JP)

(72) Inventor: YUKI SHIRAKAWA, Kanagawa (JP)

(21) Appl. No.: 18/356,709

(22) Filed: Jul. 21, 2023

Related U.S. Application Data
(63) Continuation of application No. PCT/JP2021/047909, filed on Dec. 23, 2021.

(30) Foreign Application Priority Data
Jan. 22, 2021 (JP) 2021-009130

(51) Int. Cl. H04L 9/40

(52) U.S. Cl. CPC H04L 63/0861; H04L 63/0876; H04L 63/0435

(57) ABSTRACT

In a mechanism in which an information processing apparatus that executes an application for controlling authentication processing using an external authenticator worn by a user transmits signature data received in a case where the authentication using the external authenticator is successful to a system and the signature data is verified, the external authenticator provides a notification to the user in response to at least one of a result of the authentication by the external authenticator and a request transmitted from the information processing apparatus to the external authenticator.

### CROSS-REFERENCE TO RELATED APPLICATIONS

This application is a Continuation of International Patent Application No. PCT/JP2021/047909, filed Dec. 23, 2021, which claims the benefit of Japanese Patent Application No. 2021-009130, filed Jan. 22, 2021, both of which are hereby incorporated by reference herein in their entirety.

### BACKGROUND OF THE INVENTION

### Field of the Invention

The present invention relates to an authentication technique using an authenticator.

### Background Art

There are numerous authentication methods for logging in to a service on a web and/or approving use of a service on a web. An example of an authentication method that has drawn attention in recent years is Fast Identity Online (FIDO). With FIDO, authentication information, such as biometric information, is not circulated on a network, so that FIDO is considered as an authentication method with a low risk of information leakage.

Fingerprint authentication using a fingerprint authentication reader and face authentication using a camera are widely used as biometric information input methods. In Patent Document 1, a smartphone is used as an external authenticator (authenticator) in FIDO authentication. In recent years, wearable terminals, such as smartwatches, smart rings, and earphones, are equipped with sensors for reading biometric information, and personal authentication is realized using vein authentication, skin authentication, ear acoustic authentication, or the like. These types of wearable terminals are also usable as an authenticator in an authentication method, such as FIDO.

### Citation List

Patent Literature

PTL 1: Japanese Patent Laid-Open No. 2020-95687

In a case where a wearable terminal is used as an external authentication unit and an authentication method such as vein authentication, skin authentication, and ear acoustic authentication is used, the authentication may be performed smoothly without an input of a specific operation, such as placing a finger over a predetermined position of a smartphone.

On the other hand, since the authentication is made possible without a user operation just by the user wearing the wearable terminal, it may be difficult for the user to recognize an authentication processing result and a timing of the authentication successfully completed. Unlike smartphones, wearable terminals, such as earphones, may not include a display. In this case, the above-described concern becomes prominent. In particular, in a case where a wearable terminal is used as an external authenticator in approving of the use of a service (item purchase) using FIDO, the user may wish to recognize a result of authentication processing in real time.

The present invention is directed to providing a mechanism with which a notification associated with authentication processing is appropriately provided to a user even in a case where a wearable terminal is used as an authenticator.

### SUMMARY OF THE INVENTION

An information processing apparatus configured to execute an application for controlling authentication processing using an external authenticator connected to the information processing apparatus is characterized by including a first transmission unit configured to transmit a request to a system configured to communicate via a network, a first reception unit configured to receive verification data from the system, a request unit configured to transmit an authentication request including the verification data to the external authenticator, a second reception unit configured to receive, from the external authenticator, signature data generated by the external authenticator, a second transmission unit configured to transmit the signature data to the system, and a third reception unit configured to receive data based on a result of verification processing on the signature data using a public key registered in the system. The external authenticator is worn by a user of the information processing apparatus. The external authenticator provides a notification to the user in response to at least one of a result of biometric authentication in response to the authentication request, and a request transmitted from the information processing apparatus to the external authenticator in response to the third reception unit receiving the data.

Further features of the present invention will become apparent from the following description of exemplary embodiments with reference to the attached drawings.

### BRIEF DESCRIPTION OF THE DRAWINGS

FIG. 1 is a diagram illustrating an example of a system configuration and a network configuration.

FIG. 2A is a diagram illustrating an example of a hardware configuration of an information processing apparatus building a server system.

FIG. 2B is a diagram illustrating an example of a hardware configuration of a wearable terminal.

FIG. 2C is a diagram illustrating an example of a hardware configuration of a client terminal.

FIG. 3A is a diagram illustrating an example of a software module configuration of the client terminal.

FIG. 3B is a diagram illustrating an example of a software module configuration of the wearable terminal.

FIG. 3C is a diagram illustrating an example of a software module configuration of the server system.

FIG. 4 is a diagram illustrating an example of a sequence in registering an authenticator.

FIG. 5A is a diagram illustrating an example of a data structure of registration parameters 510.

FIG. 5B is a diagram illustrating an example of a data structure of registration request data 520.

FIG. 5C is a diagram illustrating an example of a data structure of credentials 530.

FIG. 5D is a diagram illustrating an example of a data structure of registration data 540.

FIG. 6A is a diagram illustrating an example of an authentication setting screen provided by an application.

FIG. 6B is a diagram illustrating an example of a registration screen displayed on the client terminal.

FIG. 6C is a diagram illustrating an example of a screen indicating that an authenticator search is being performed on the client terminal.

FIG. 6D is a diagram illustrating an example of an authenticator registration confirmation screen displayed on the client terminal 102.

FIG. 6E is a diagram illustrating an example of a screen indicating that an authenticator registration is being performed on the client terminal.

FIG. 6F is a diagram illustrating an example of a registration completion screen displayed on the client terminal.

FIG. 7 is a diagram illustrating an example of a sequence in using a service including authentication.

FIG. 8A is a diagram illustrating an example of authentication parameters 810.

FIG. 8B is a diagram illustrating an example of authentication request parameters 820.

FIG. 8C is a diagram illustrating an example of assertion information 830.

FIG. 9A is a diagram illustrating an example of a screen provided by a web service.

FIG. 9B is a diagram illustrating an example of a screen indicating that an authentication is being performed to use a service.

FIG. 9C is a diagram illustrating an example of an authentication completion screen.

FIG. 9D is a diagram illustrating an example of a screen indicating that the use of the service has been accepted.

FIG. 10 is a diagram illustrating an example of a sequence in using a service including authentication according to a third exemplary embodiment.

FIG. 11A is a diagram illustrating an authenticator registration confirmation screen according to a first modified example.

FIG. 11B is a diagram illustrating an authenticator registration confirmation screen according to a second modified example.

### DESCRIPTION OF THE EMBODIMENTS

Best modes for implementing the present invention will be described below with reference to the drawings. In the description below, biometric authentication is performed using a wearable terminal that is owned and is worn by a user to use a service on a web. The description is about a mechanism in which data (signature data) that enables proving a successful authentication is provided to the service on the web and the service is provided in a case where the data is successfully verified by the service. While Fast Identity Online (FIDO) is used as an example of the mechanism according to the exemplary embodiments described below, any similar authentication mechanism using a technique other than FIDO is adoptable.

### First Exemplary Embodiment

<Network Configuration>

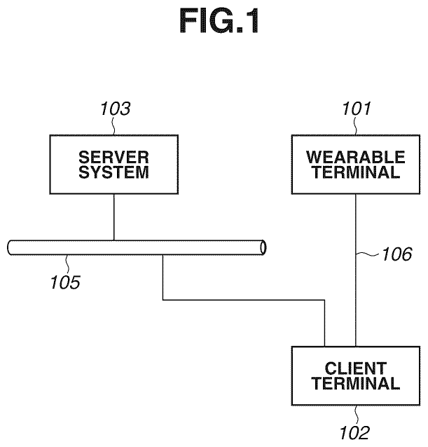

FIG. 1 is a diagram illustrating an example of a network configuration according to the present exemplary embodiment. This system includes a wearable terminal 101, a client terminal 102, and a server system 103.

The client terminal 102 and the server system 103 are connected together via a network 105. The network 105 is a so-called communication network realized by, for example, a local area network (LAN), a wide area network (WAN), the Internet, a telephone line, a dedicated digital line, an Asynchronous Transfer Mode (ATM) line, a frame relay line, a cable television line, a wireless line for data broadcasting, and a combination thereof. Further, the wearable terminal 101 is also connected to the client terminal 102 via a network 106. The network 106 is realized by, for example, short-range wireless communication, such as Near Field Communication (NFC) and Bluetooth®, or by communication via a connected universal serial bus (USB) cable. The network 106 may be realized by Wi-Fi communication. Further, the wearable terminal 101 may be connected to the network 105.

### <Internal Configuration of Server System 103>

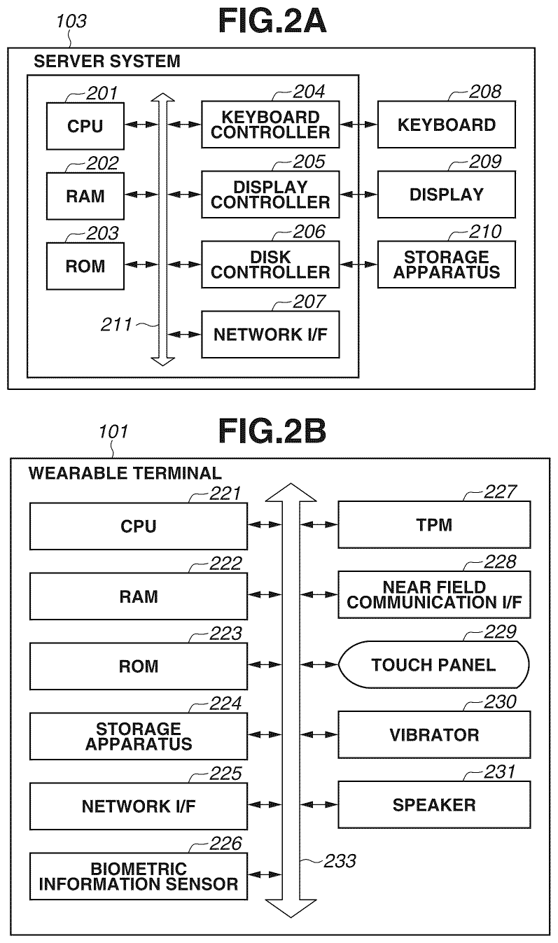

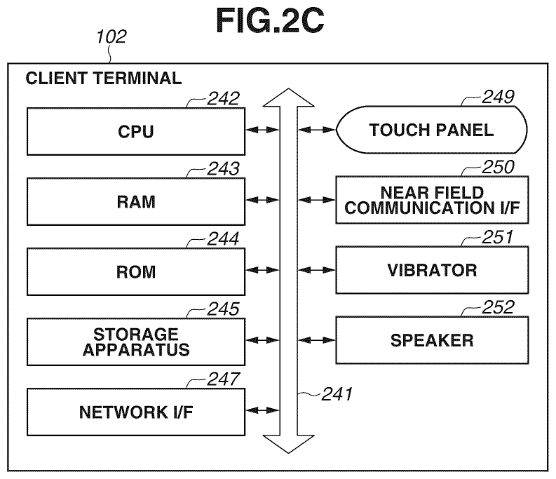

FIG. 2A is a diagram illustrating an example of a configuration of hardware including an information processing function of the server system 103. The server system 103 includes at least one or more information processing apparatuses and provides a website, a web service, and an authentication service using hardware of the apparatuses, which will be described below.

A central processing unit (CPU) 201 executes programs read from a random access memory (RAM) 202, a read-only memory (ROM) 203, or a storage apparatus 210. A keyboard controller 204 controls input operations from a keyboard 208 and pointing devices (mouse, touch pad, touch panel, trackball, and the like), which are not illustrated. A display controller 205 controls displays on a display 209. A disk controller 206 controls access to data in the storage apparatus 210, such as a hard disk drive (HD) and a solid state drive (SSD), storing various types of data. A network interface 207 is connected to a network, such as a LAN, and communicates with other devices connected to the network. Each unit included in the hardware, such as the components 201 to 207, are connected together via an internal bus 211.

### <Internal Configuration of Wearable Terminal 101>

FIG. 2B is a diagram illustrating an internal configuration of the wearable terminal 101.

A CPU 221 is provided with programs (including programs for realizing processing described below) stored in a ROM 223 and comprehensively controls each device via an internal bus 233. A RAM 222 functions as a memory and a work area of the CPU 221. A storage apparatus 224 is an HD, SSD, or the like storing various types of data. A network interface (network I/F) 225 one-directionally or bi-directionally transmits and receives data to and from external network devices. A biometric information sensor 226 is a sensor that reads biometric information for vein authentication, skin authentication, ear acoustic authentication, or the like. A trusted platform module (TPM) 227, which is a storage unit, has a tamper-proofing feature that prevents stored data from being read by external sources, in order to process or store confidential information. The TPM 227 stores biometric information input via the biometric information sensor 226 and private keys generated in the wearable terminal 101 and has a function of verifying stored biometric information against input biometric information. As the storage unit with the tamper-proofing feature, a securely-configured reliable environment uniquely defined by a platform, such as an operating system (OS) of the wearable terminal 101, is useable.

A near field communication interface (near field communication I/F) 228 is a network interface (I/F) for near field communication, such as NFC and Bluetooth®. Use of the near field communication I/F 228 makes it possible to transmit and receive data to and from the client terminal 102 and the like and to issue authentication instructions from the client terminal 102 to the wearable terminal 101. A touch panel 229 is an apparatus having both a display function and a pointing function, and the user can operate objects displayed on a display with a finger of the user, a touch pen, or the like. A vibrator 230 is an apparatus for vibrating the wearable terminal 101 in response to a user operation, an external event, or the like. A speaker 231 is an apparatus for outputting a sound, such as an audio message and a melody.

While it is assumed in the present invention that the wearable terminal 101 is a smartwatch, earphones, or a smart ring having a vein authentication function, a skin authentication function, an ear acoustic authentication function, or the like to enable authentication with the user wearing the wearable terminal 101, the wearable terminal 101 is not limited to a specific device. Further, while a display output apparatus, such as the touch panel 229 in FIG. 2B, is included, the present invention does not necessarily require a display output apparatus. Furthermore, while the vibrator 230 and the speaker 231 of the wearable terminal 101 according to the present exemplary embodiment are used to notify the user of completion of processing, notification apparatuses are not limited to those described above. For example, an apparatus for tightening a belt is providable for a smartwatch, and a light that blinks is providable for a smart ring.

### <Internal Configuration of Client Terminal>

FIG. 2C is a diagram illustrating an example of a hardware configuration of an information processing apparatus that is the client terminal 102.

An internal bus 241, a CPU 242, a RAM 243, and a ROM 244 have functions similar to those of the internal bus 211, the CPU 201, the RAM 202, and the ROM 203, respectively. A storage apparatus 245 is a storage apparatus, such as an SSD or a secure digital (SD) memory card, and stores various types of data similarly to the storage apparatus 210. A network interface 247 is a communication module having a wireless communication function to communicate with other devices connected to the network. A touch panel 249 is an apparatus that has both a display function and a pointing function, like the touch panel 229, and the user can operate objects displayed on a display with a finger of the user or a touch pen. A near field communication I/F 250, a vibrator 251, and a speaker 252 have functions similar to those of the near field communication I/F 228, the vibrator 230, and the speaker 231, respectively.

While it is assumed in the present invention that the client terminal 102 is an information processing terminal, such as a smartphone, a personal computer (PC), and a tablet computer, the client terminal 102 is not limited to a specific device. For example, the client terminal 102 may be a device without a display or a touch panel, such as a smart speaker and smart glasses.

### <Software Configuration of Client Terminal 102>

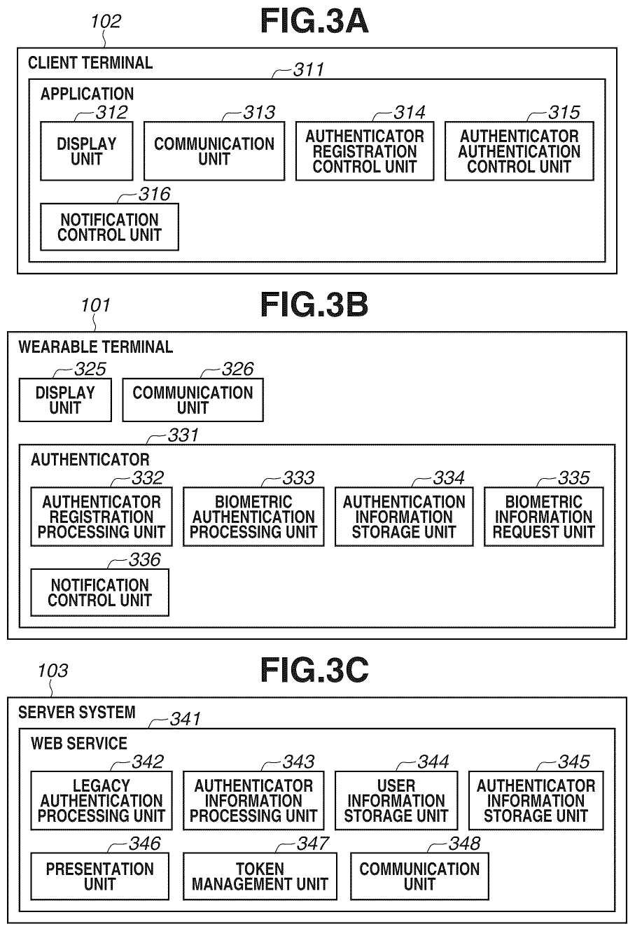

FIG. 3A is a diagram illustrating an example of a software configuration of the client terminal 102.

An application 311 is used for using a service provided by a web service 341 of the server system 103. The application 311 includes a display unit (UI) 312, a communication unit 313, an authenticator registration control unit 314, an authenticator authentication control unit 315, and a notification control unit 316.

The application 311 is a web browser or a native application dedicated to the use of the web service 341. The display unit 312 is a software module for executing and displaying web content acquired from the web service 341. The communication unit 313 is a software module for communicating with the server system 103 and the wearable terminal 101. The authenticator registration control unit 314 is a software module that requests an authenticator 331 to generate a credential (described below) and generates a requests that is to be transmitted to the web service 341 during authenticator registration. The authenticator authentication control unit 315 issues an authentication processing request to the authenticator 331 and generates a request that is to be transmitted to the web service 341 during authentication. The notification control unit 316 is a software module for providing and controlling notification of an authentication result to the user during authentication, which is a characterizing feature of the present invention. Conditions or timings and patterns of notifications to be performed by the notification control unit 316 will be described below. The user operates the display unit 312, and the communication unit 313 communicates with the server system 103, so that a service provided by the web service 341 is available.

Specific processing sequences of authenticator registration and user authentication will be described below.

### <Software Configuration of Wearable Terminal 101>

FIG. 3B is a diagram illustrating an example of a software configuration of the wearable terminal 101.

A display unit 325 is a software module for providing a graphical user interface (GUI) to the user via the touch panel 229. A communication unit 326 is a software module for communicating with external devices, such as the client terminal 102, via a network interface 225.

The authenticator 331 is an authentication module group configured to perform processing relating to biometric authentication using the biometric information sensor 226. Executing the authenticator 331 enables the wearable terminal 101 according to the present exemplary embodiment to function as an external authenticator of the client terminal 102.

An authenticator registration processing unit 332 is a software module that receives a credential generation request from the authenticator registration control unit 314 and the like, generates a pair of keys (private key and public key), and generates a credential. A biometric authentication processing unit 333 is a software module that receives a biometric authentication request from the authenticator authentication control unit 315 and performs biometric authentication using the biometric information sensor 226. An authentication information storage unit 334 is a software module that stores, in the TPM 227, authentication information indicated in an authentication information management table (Table 1). A biometric information request unit 335 is a software module that displays, on the touch panel 229, a user interface (UI) for receiving input biometric information from the user. Since some types of the wearable terminal 101 do not include a display output apparatus for displaying a UI, such as the touch panel 229, the display unit 325 is not an essential element for the present invention, as with the touch panel 229. A notification control unit 336 is a software module that provides and controls an authentication result notification to the user during authentication, which is a characterizing feature of the present invention. Timings and patterns of notifications to be performed by the notification control unit 336 will be described below.

### <Example of Table Managed by Authenticator 331 of Wearable Terminal 101>

In an authentication information management table, or Table 1, each record specifies a single entry of authentication information.

TABLE 1
Authentication Information Management Table

| Authentication | | | | Biometric |
|---|---|---|---|---|
| Information ID | Service ID | User ID | Private Key | Information ID |
| 407c-8841-79d | xxxmarket.com | user001 | 1faea2da-a269-4fa7-812a-509470d9a0cb | d493a744 |
| 4c04-428b-a7a2 | xxxmarket.com | user001 | d7ae30c8-3775-4706-8597-aaf681bc30f5 | dcc97daa |
| 92b2-498d-bea6 | xxxmarket.com | user001 | 36ae5eed-732b-4b05-aa7b-4dddb4be3267 | 51caacaa |
| . . . | . . . | . . . | . . . | . . . |

The authentication information ID column stores unique identification information (ID) for each piece of authentication information. The service ID column stores identification information (service ID) for identifying a target service, such as the web service 341. The authentication information management table stores a domain name of each web service as a service ID. The user ID column stores user identification information (user ID) for a web service to uniquely identifying a user, which is to be used in legacy authentication and the like. The legacy authentication is the authentication performed by verifying whether a user ID and a password match, and the term “legacy authentication” is used as distinguished from biometric authentication. The private key column stores identifiers of private keys generated by the authenticator registration processing unit 332. Public keys corresponding to the private keys managed using the identifiers stored in the private key column are registered with services on the network that correspond to a service ID specified in the service ID column and are managed by the service. The biometric information ID column stores identification information (ID) corresponding to a feature amount of biometric information.

A process of storing the data to be managed in the columns of the authentication information management table and a process of transmitting a public key to the web service 341 and storing the public key will be described below.

<Software Configuration of Server>

FIG. 3C is a diagram illustrating an example of a software configuration of the server system 103.

The web service 341 provides a service using communication protocols, such as Hypertext Transfer Protocol (HTTP), and requires user authentication. The web service is prepared for each service to be provided. More specifically, the web service provides a social networking service, an electric commerce (E-commerce) service, a financial service, and websites for these services.

Each web service is realized by the CPU 201 reading a program for providing the web service stored in the ROM 203 of the server system 103 to the RAM 202 and executing the read program. A legacy authentication processing unit 342 is a software module that verifies whether a user ID and a password that are included in a legacy authentication request received by a communication unit 348 match a user ID and a password that are stored in a user information storage unit 344. An authenticator information processing unit 343 is a software module that stores authenticator information in an authenticator information storage unit 345 using the credential received by the communication unit 348. Further, the authenticator information processing unit 343 verifies assertion information (Assertion) received by the communication unit 348, which will be described below. The user information storage unit 344 is a software module that stores user information described below using a user information management table. The authenticator information storage unit 345 is a software module that stores authenticator information described below using an authenticator information management table. A presentation unit 346 is a software module that generates a Hypertext Markup Language (HTML), Cascading Style Sheets (CSS), JavaScript, and the like based on a request to acquire various screens of the web service 341 received from the client terminal 102 and the like by the communication unit 348. A token management unit 347 is a software module that issues tokens and verifies tokens, which will be described below, using a token management table. The communication unit 348 is a software module that communicates with the client terminal 102 and receives requests.

### <Examples of Tables Managed by Server System 103>

Table 2 is the user information management table managed by the user information storage unit 344 of the web service 341. In the user information management table, each record specifies a piece of account information about a single registered user.

TABLE 2
User Information Management Table

| User ID | Password | Email Address |
|---|---|---|
| user001 | ****** | user001@xxx.co.jp |
| user002 | ****** | user002@xxx.co.jp |
| . . . | . . . | . . . |

The user ID column stores user identifiers (user ID) for uniquely identifying each user of the web service 341. The password column stores passwords for authenticating the users. The passwords are to be used in legacy authentication and are usually hashed and stored. The email address column stores email addresses of the users. The user information management table may also store user attribute information other than email addresses, such as addresses and profiles of the users.

Table 3 is an attestation challenge management table managed by the user information storage unit 344 of the web service 341.

TABLE 3
Attestation Challenge Management Table

| Attestation Challenge | User ID | Expiration Date and Time |
|---|---|---|
| 65C9B063-9C33 | user001 | 2017-05-02T12:00:34Z |
| 7317EFBA-4E63 | user002 | 2017-05-02T12:03:12Z |
| . . . | . . . | . . . |

In the attestation challenge management table indicated in Table 3, each record indicates a piece of information about a single attestation challenge. Each attestation challenge is data issued in registering a credential for a user and is a parameter for use as verification data for challenge response authentication. Attestation challenge issuing processing will be described below. The attestation challenge column stores attestation challenges. The user ID column indicates user IDs in association with the issued attestation challenges. The expiration date and time column indicates expiration date and time of the respective attestation challenges.

Table 4 is the authenticator information management table that is managed by the authenticator information storage unit 345 of the web service 341.

TABLE 4
Authenticator Information Management Table

| Authentication | | | Notification |
|---|---|---|---|
| Information ID | Public Key | User ID | Capability |
| 407c-8841- | AC43C5FB-BFA2-48D1-A71B- | user001 | Supported |
| 79d | FB04ACDA347A | | |
| 4c04-428b- | 8143CA9F-35C9-4333-948F- | user001 | Not |
| a7a2 | BFCE66A74310 | | Supported |
| . . . | . . . | . . . | . . . |

In the authenticator information management table indicated in Table 4, each record indicates a single piece of authenticator information. The authentication information ID column stores values stored in the authentication information ID column of the authentication information management table (Table 1). The public key column manages public key information for which registration as a credential has been requested by an authenticator. Each public key is to be paired with a private key in association with an authentication information ID. More specifically, data encrypted with a private key by an authenticator can be decrypted with a public key that is managed in the authenticator information management table by the web service 341, for the pair of keys that is managed using the same authentication information ID.

The user ID column stores a user ID for uniquely identifying a user using the web service 341. The notification capability column stores capability information indicating whether the wearable terminal 101 includes the notification control unit 336 (whether a notification function according to the present exemplary embodiment is supported). The information is used in notification determination, which is a characterizing feature of the present invention.

Table 5 is the token management table managed by the token management unit 347 of the web service 341.

TABLE 5
Token Management Table

| Token | User ID | Expiration Date and Time |
|---|---|---|
| 3FD4FA-AA4-56DC-B45F-45BCD65AC45D | user001 | 2017-05-02T13:14:31Z |
| EC51DC-36C4-4BC3-54CF-31ECE6CACBF0 | user002 | 2017-05-02T13:31:32Z |
| . . . | . . . | . . . |

The tokens managed in Table 5 are issued by the token management unit 347 of the web service 341 after various types of authentication processing are ended. To use the web service 341, the application 311 transmits a request with an issued token provided, so that a service provided by the web service 341 is available.

In the token management table, each record specifies a piece of information about a single token. The token column stores token information. The user ID column stores user IDs for uniquely identifying users of the web service 341. The expiration date and time column specifies expiration date and time of the respective tokens.

The web service 341 receives a request in a case where a token provided to the request is present in the token column of the token management table and the corresponding expiration date and time in the expiration date and time column has not passed.

### <Authenticator Registration Processing>

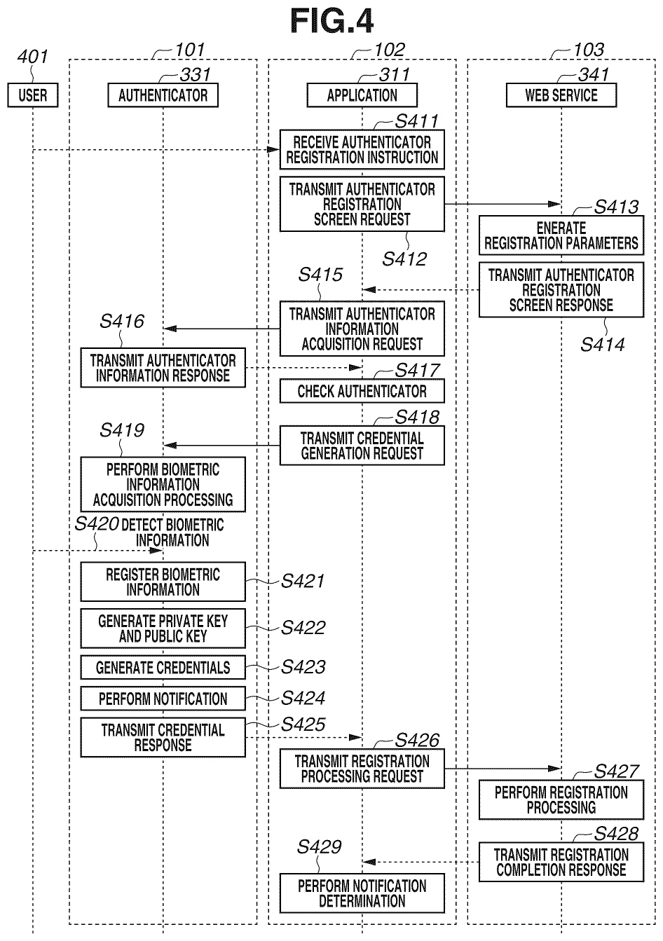

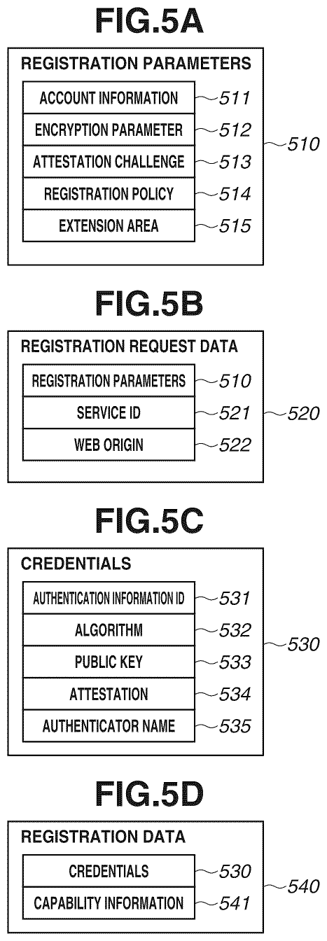

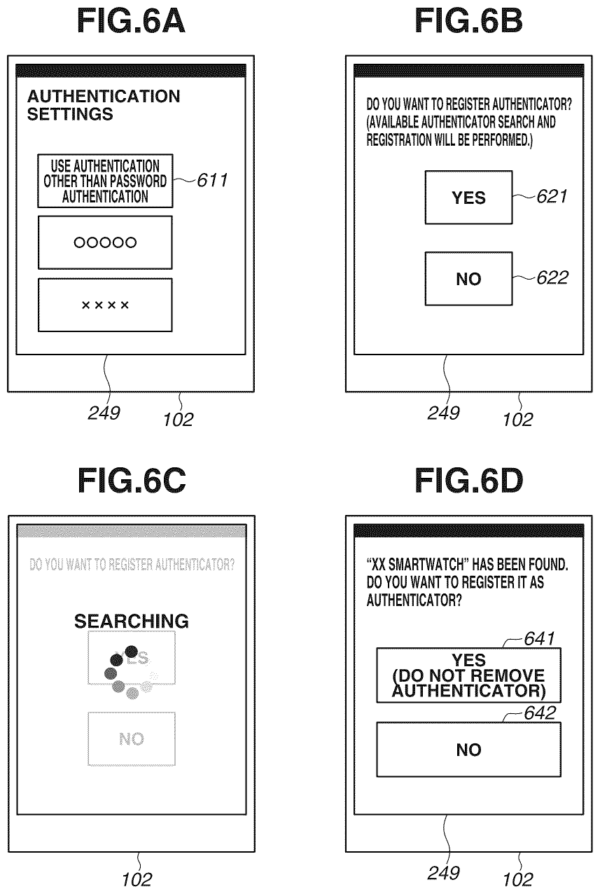

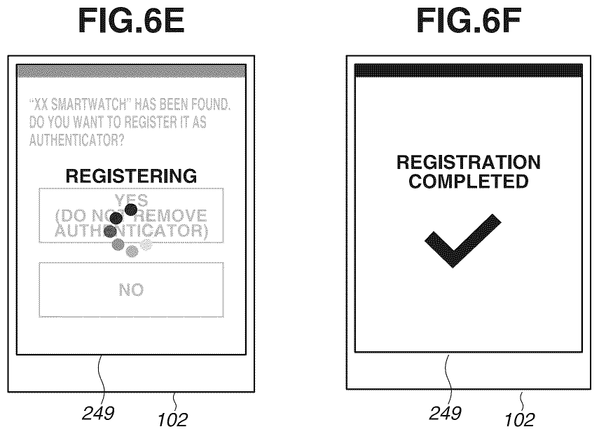

Authenticator registration processing illustrated in FIG. 4 will be described below with reference to FIGS. 5A to 5D and 6A to 6F. The processing illustrated in FIG. 4 illustrates processing steps that are realized by the apparatuses executing corresponding programs. An example of registering information generated by the authenticator 331 of the wearable terminal 101 will be described below. Hereinafter, the registration of information generated by the authenticator 331 in the web service 341 will be simply referred to as authenticator registration.

FIGS. 5A to 5D are diagrams illustrating examples of parameters included in communications between the wearable terminal 101, the client terminal 102, and the server system 103. FIGS. 6A to 6F are diagrams illustrating examples of UIs that are controlled and displayed by the display unit 312 of the application 311 during the processing of authenticator registration.

FIG. 6A illustrates an authentication setting screen provided by the application 311. Initially, in a case where a user is to use an authentication method other than legacy authentication (password authentication) in using the web service 341, the user presses a button 611. The authentication setting screen is provided in a case where a user 401 is authenticated by the web service 341 using legacy authentication.

In step S411, the application 311 receives a registration instruction corresponding to the selection of the button 611 by the user.

In step S412, the authenticator registration control unit 314 of the application 311 transmits an authenticator registration screen request to the web service 341 via the communication unit 313.

In step S413, the authenticator information processing unit 343 of the web service 341 generates registration parameters 510.

The registration parameters 510 will be described below with reference to FIG. 5A. The registration parameters 510 include account information 511, an encryption parameter 512, an attestation challenge 513, a registration policy 514, and an extension area 515. The account information 511 indicates a user ID identified in the authentication performed by the web service 341 and attribute information, such as an email address, in association with the user ID. The encryption parameter 512 indicates attribute information about authentication information to be registered, such as an encryption algorithm supported by the web service 341. The attestation challenge 513 is a parameter serving as verification data to be used for performing challenge response authentication. The attestation challenge 513 is generated during the registration parameter generation in step S413 and stored in association with the user ID, an expiration date and time, and the like in the attestation challenge management table (Table 3). The registration policy 514 is an optional parameter for designating a type of authenticator that is registerable in the web service 341. A policy indicates, for example, whether the wearable terminal 101 to serve as an authenticator supports an authentication method designated by the web service 341 or has a specific capability. The extension area 515 stores an extension parameter that the web service 341 is able to designate in order for the web service 341 to control operations of the authenticator 331 and the application 311.

In step S414, the authenticator information processing unit 343 of the web service 341 transmits authenticator registration screen information to the application 311 as a response to the request in step S412. The response to be transmitted also includes the registration parameters 510.

FIG. 6B illustrates an example of a registration screen that is controlled and displayed on the touch panel 249 of the client terminal 102 by the application 311 based on the response in step S414. In a case where a button 621 is operated by the user, in step S415, search processing is performed, whereas in a case where a button 622 is operated, the screen returns to the screen illustrated in FIG. 6A.

FIG. 6C is a screen that is displayed on the touch panel 249 while the operations in steps S415 and S416 are being performed.

In step S415, the authenticator registration control unit 314 searches for a device that is connected to the client terminal 102 and is usable as an authenticator (external authenticator). More specifically, a request to acquire authenticator information is transmitted to a wearable terminal that is a connected device. In a case where an authenticator program is being executed by the wearable terminal, the wearable terminal is able to respond to the request. According to the present exemplary embodiment, the authenticator registration control unit 314 transmits this request to the communication unit 326 of the wearable terminal 101 via the communication unit 313 of the application 311.

The requested authenticator information includes the notification capability of the authenticator described in conjunction with the authenticator information management table.

In step S416, the authenticator registration processing unit 332 receives the request via the communication unit 326 of the wearable terminal 101 and responds with authenticator information to the application 311.

In step S417, the authenticator registration control unit 314 checks whether the authenticator information acquired in step S416 satisfies the condition of the registration policy 514 included in the response in step S414 and whether use as an authenticator of the web service 341 is possible.

FIG. 6D is a screen that is displayed on the touch panel 249 in a case where it is determined that use as an authenticator of the web service 341 is possible, as a result of the processing in step S417. In a case where a button 641 is operated to be selected by the user, the operation in step S418 is performed and the screen changes to a screen illustrated in FIG. 6E. Further, in a case where a button 642 is selected, the screen returns to the screen illustrated in FIG. 6A.

While the sequence in FIG. 4 does not illustrate, the screen in FIG. 6D may be skipped and the operation in step S418 may be performed, with a setting of not requesting the user to determine whether to register an authenticator, such as a setting of always using a fixed external authenticator. Further, skipping of the operations in step S417 and the subsequent steps is also implementable in a case where no available authenticators are found or a setting of not using an external authenticator is set.

In step S418, the authenticator registration control unit 314 of the application 311 transmits a credential generation request to the wearable terminal 101 via the communication unit 313. The credential generation request is received by the communication unit 326 of the wearable terminal 101, and the communication unit 326 transmits the received request to the authenticator registration processing unit 332. The credential generation request in step S418 includes registration request data 520.

The registration request data 520 will be described below with reference to FIG. 5B. The registration request data 520 includes the registration parameters 510 received from the web service 341, a service ID 521 of the web service 341 in the authentication information management table (Table 1) described above, and a Web Origin 522. The Web Origin 522 is information that indicates an origin of the web service 341.

In step S419, the authenticator registration processing unit 332 performs biometric information acquisition processing to acquire biometric information about the user. More specifically, the biometric information sensor 226 is instructed to internally read biometric information. In step S420, biometric information about the user 401 wearing the wearable terminal 101 is detected via the biometric information sensor 226. It is assumed in the present invention that the biometric information detection is performed without an operation on the wearable terminal 101 while the user 401 simply wears the wearable terminal 101.

In step S421, the authenticator registration processing unit 332 of the authenticator 331 generates a feature amount of the read biometric information and a biometric information ID for uniquely identifying the read biometric information. In step S422, the authenticator registration processing unit 332 of the authenticator 331 generates a pair of a private key and a public key and issues an authentication information ID. The authenticator registration processing unit 332 then stores, in the authentication information storage unit 334, the authentication information ID, the private key, and the biometric information ID that are generated in step S421 or S422, the service ID 521 included in the registration request data 520, and the user ID included in the registration parameters 510.

In step S423, the authenticator registration processing unit 332 of the authenticator 331 generates credentials 530 illustrated in FIG. 5C. The credentials 530 include an authentication information ID 531, an algorithm 532, a public key 533, an attestation 534, and an authenticator name 535.

The authentication information ID 531 and the public key 533 are the public key generated by the processing in step S422. The algorithm 532 corresponds to an algorithm that has been used to generate the pair of the private key and the public key in step S422. Further, the attestation 534 is the attestation challenge 513 that is encrypted with the private key generated in step S422.

In step S424, the notification control unit 336 notifies the user 401 that the input of the biometric information is completed, using at least one of the vibrator 230 and the speaker 231 of the wearable terminal 101. The user 401 can recognize the notification through a vibration and/or a specific sound from the wearable terminal 101.

The notification means to be used in the operation in step S424 is different depending on the types of the wearable terminal 101. For example, for a smartwatch, a method for notification by applying a vibration or by tightening a belt is useable. For earphones, a method for notification using a sound is useable. For a smart ring, a method for notification by blinking a light is useable.

Further, in a case where the wearable terminal 101 does not include an apparatus, such as a notification control unit 329, the vibrator 230, and the speaker 231, the operation in step S424 can be skipped, and in step S429 described below, the application 311 can notify the user 401 that the input of the biometric information is completed.

In step S425, the authenticator registration processing unit 332 of the authenticator 331 responds with the credentials 530 generated in step S423 to the application 311 of the client terminal 102.

In step S426, the authenticator registration control unit 314 transmits a registration processing request including registration data 540 to the web service 341 via the communication unit 313.

The registration data 540 will be described below with reference to FIG. 5D. The registration data 540 includes the credentials 530 and capability information 541. The credentials 530 are the credentials generated in step S423. The capability information 541 is the authenticator information for the wearable terminal 101 which has been acquired in steps S415 and S416.

In step S427, the authenticator information processing unit 343 of the web service 341 performs authenticator registration processing using the registration data 540 of the registration processing request received in step S426. The registration processing includes verification processing by decrypting the attestation 534 included in the credentials 530 of the registration data 540 with the public key 533 included in the same credentials 530. Furthermore, the authenticator information processing unit 343 of the web service 341 identifies the one with a value in the attestation challenge column of the attestation challenge management table (Table 3) the same as the value obtained by decrypting the attestation 534 with the public key 533. A user ID of the same record including the value in the identified attestation challenge column is then identified as an ID to be associated with the credentials 530. The authenticator information processing unit 343 of the web service 341 registers the authentication information ID 531 included in the credentials 530, the public key 533 included in the credentials 530, the identified user ID, and the capability information 541 in the authenticator information management table. In step S428, the authenticator information processing unit 343 of the web service 341 transmits, to the application 311 via the communication unit 348, a response indicating that the authenticator registration processing is completed normally.

In step S429, the authenticator registration control unit 314 of the web service 341 performs notification determination based on the notification capability included in the authenticator information about the wearable terminal 101 that is acquired in steps S415 and S416. In a case where the authenticator registration control unit 314 determines that the notification capability is “not supported” by the wearable terminal 101, the authenticator registration control unit 314 calls the notification control unit 316, and in place of the operation in step S424, the notification control unit 316 notifies the user 401 that the input of the biometric information and the registration processing have been completed.

For example, FIG. 6F illustrates a screen that is displayed in a case where the operation in step S429 is performed by the authenticator registration control unit 314. In a case where the client terminal 102 includes an output apparatus, such as the touch panel 249 and the vibrator 251, notification indicating that the registration processing is completed is provided by displaying a screen as illustrated in FIG. 6F or by vibrating the client terminal 102.

In a case where the client terminal 102 is a device that uses only audio input/output, such as a smart speaker, the displayed items illustrated in FIGS. 6A to 6F are implemented using audio.

### <Modified Example of Operation Relating to FIG. 6D>

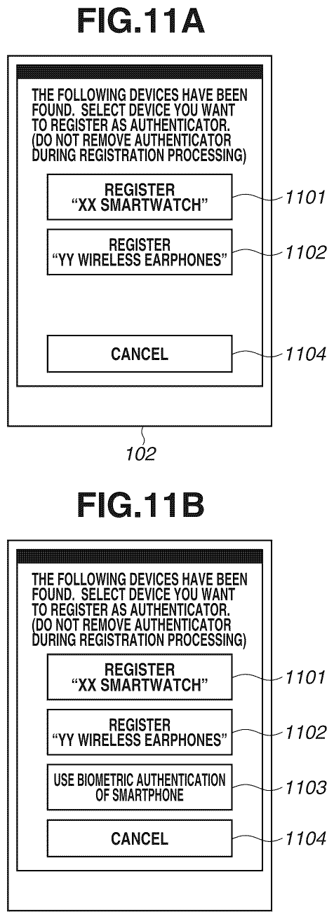

FIG. 11A illustrates a modified example of the screen illustrated in FIG. 6D. More specifically, this is an example of a case where a plurality of wearable terminals is found as a device available for use as an authenticator of the web service 341. FIG. 11B illustrates an example of a case where an internal authenticator of the client terminal 102 is also available for use as an authenticator of the web service 341 in addition to the plurality of wearable terminals.

FIGS. 11A and 11B illustrate “XX smartwatch” and “YY wireless earphones” as an example of the plurality of wearable terminals. In a case where either a button 1101 or 1102 is selected by the user, a credential generation request is issued to a wearable terminal corresponding to the selected button, and the operations in step S418 and the subsequent steps are performed.

In a case where a cancel button 1104 in FIG. 11A or 11B is selected, the screen returns to the screen illustrated in FIG. 6A.

In a case where a button 1103 in FIG. 11B is selected, a credential generation request is issued to the internal authenticator of the client terminal 102. In this case, the operations in steps S419 to S425 are performed by the internal authenticator using biometric information acquired using a biometric information sensor of the client terminal 102.

### <Authentication Processing>

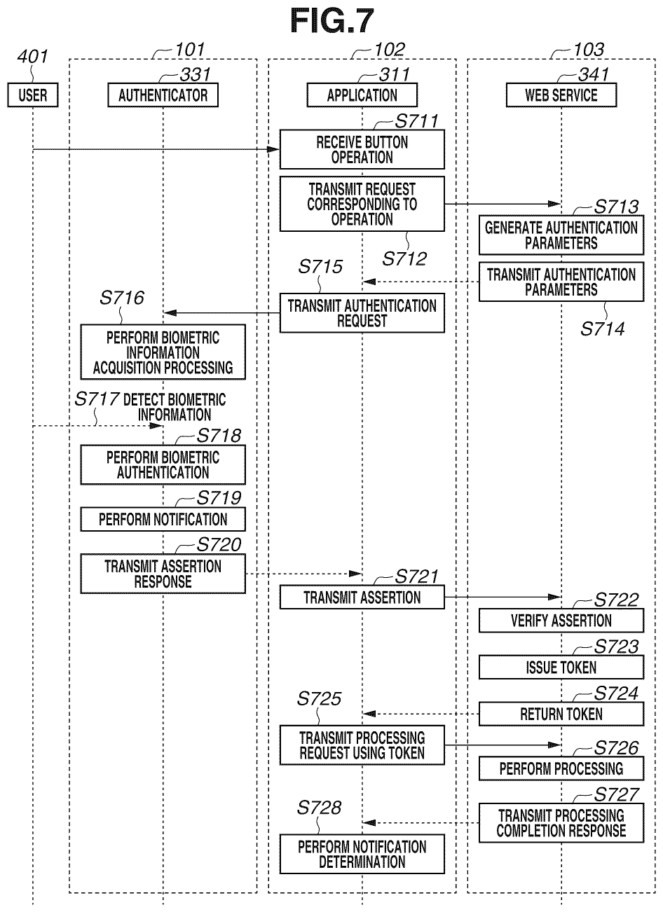

FIG. 7 is a diagram illustrating a sequence in using the web service 341 requiring authentication by the user 401 from the application 311. The processing illustrated in FIG. 7 illustrates processing steps to be realized by the apparatuses executing corresponding programs.

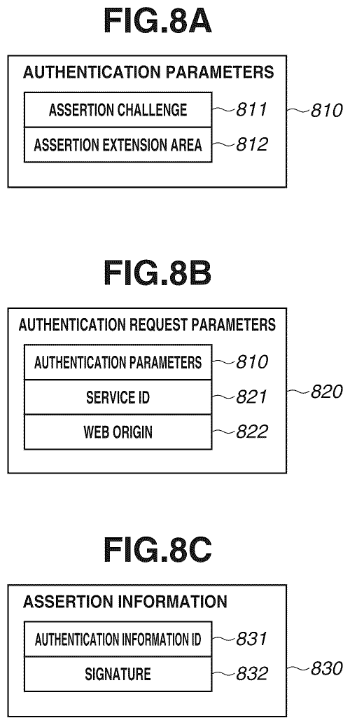

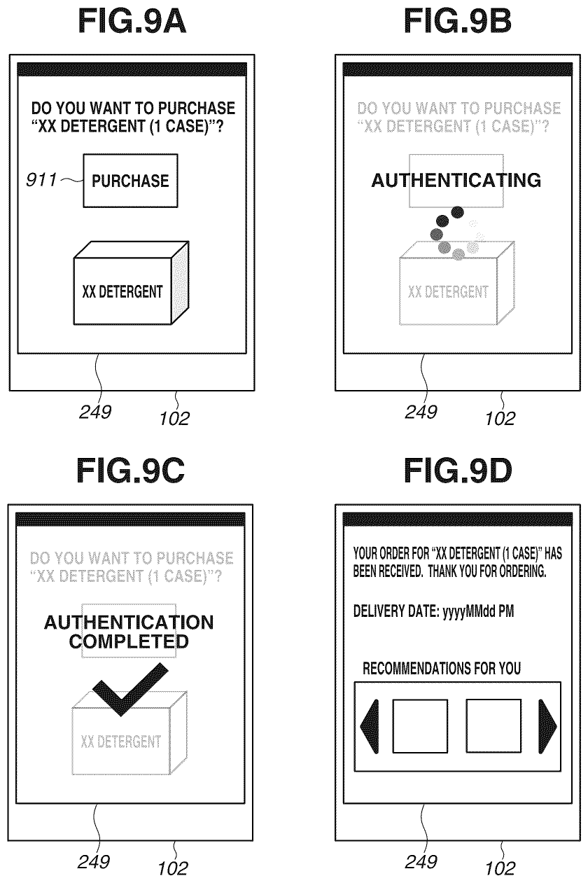

FIGS. 8A to 8C illustrate examples of parameters for use in authentication. FIGS. 9A to 9D illustrate examples of screens to be controlled and displayed by the display unit 312 of the application 311 during the processing illustrated in FIG. 7.

The present exemplary embodiment provides a mechanism for notifying the user 401 of completion of authentication processing after biometric information is input, as in the authenticator registration processing. An example of authentication processing in an item purchase procedure using the web service 341 (E-commerce site) will be described below with reference to FIGS. 7, 8A to 8C, and 9A to 9D.

Initially, FIG. 9A illustrates a screen in a case where content provided by the presentation unit 346 of the web service 341 is displayed by the display unit 312 of the application 311.

In step S711, the application 311 receives an instruction corresponding to an operation of selecting a button 911 by the user 401. In step S712, the authenticator authentication control unit 315 of the application 311 transmits an item purchase request to the web service 341.

In step S713, the authenticator information processing unit 343 of the web service 341 generates authentication parameters 810 for authenticating the user. In step S714, the authenticator information processing unit 343 of the web service 341 transmits the authentication parameters 810 generated in step S713 to the application 311.

FIG. 8A illustrates the authentication parameters 810. The authentication parameters 810 includes an assertion challenge 811 and an assertion extension area 812. The assertion challenge 811 is a parameter for use as verification data for challenge response authentication. The assertion extension area 812 stores an extension parameter that can be designated by the web service 341 to control operations of the authenticator 331 and the application 311. In the present case, the assertion extension area 812 stores the capability information 541 about the authenticator 311 that is provided in step S426.

In step S715, the authenticator authentication control unit 315 of the application 311 transmits an authentication request to the biometric authentication processing unit 333 of the authenticator 331 using authentication request parameters 820. At this time, the display unit 312 displays a screen illustrated in FIG. 9B.

FIG. 8B illustrates authentication request parameters 820. The authentication request parameters 820 include the authentication parameters 810, a service ID 821, and a Web Origin 822. The service ID 821 and the Web Origin 822 are the same as those illustrated in FIG. 5B.

In step S716, the biometric information request unit 335 of the authenticator 331 performs biometric information acquisition processing to acquire biometric information about the user. Here, an operation similar to the operation in step S419 is performed. In step S717, biometric information about the user 401 wearing the wearable terminal 101 is detected via the biometric information sensor 226. In the present invention, it is assumed that the biometric information detection is performed without an operation on the wearable terminal 101 while the user 401 simply wears the wearable terminal 101.

In step S718, the biometric authentication processing unit 333 of the authenticator 331 checks the biometric information detected via the biometric information sensor 226 against the biometric information stored in the TPM 227 and performs user authentication. Feature point extraction method and pattern matching method are generally known as matching algorithms, the present invention is not limited to any specific matching algorithm. Thereafter, the authentication information storage unit 334 identifies the corresponding private key from the authentication information management table based on the biometric information stored in the TPM 227. Then, data of a signature (832) is generated based on the assertion challenge 811 included in the authentication parameters 810 and the identified private key. Furthermore, the biometric authentication processing unit 333 generates assertion information 830 including authentication information ID 831 identified from the authentication information management table (Table 1) and the signature 832.

In step S719, the notification control unit 336 of the authenticator 331 performs notification processing. The notification control unit 336 notifies the user 401 of a result of the biometric authentication performed in step S718 using the vibrator 230, the speaker 231, and/or the like. In step S719, the notification control unit 336 is able to change a notification pattern based on the authentication result in step S718. For example, in a case where the wearable terminal 101 to be used as an external authentication unit is earphones, the notification pattern is controlled so that in a case where the authentication automatically performed while the wearable terminal 101 is being worn is successful, the audio “the authentication is successful” is output, whereas in a case where the authentication is unsuccessful, the audio “the authentication is unsuccessful” is output. Regarding the operation in step S719, the wearable terminal 101 may be devoid of an apparatus such as the notification control unit 329, the vibrator 230, and the speaker 231 in step S719, as in the authenticator registration. In this case, similarly, the notification processing of step S719 is skipped, and instead, in step S728 described below, the application 311 notifies the user 401 that the input of the biometric information and the authentication have been completed.

In step S720, the biometric authentication processing unit 333 of the authenticator 331 returns the assertion information 830 generated in step S718 to the application 311.

In step S721, the authenticator authentication control unit 315 of the application 311 transmits the assertion information 830 received from the biometric authentication processing unit 333 to the web service 341.

In step S722, the authenticator information processing unit 343 of the web service 341 verifies the assertion information 830 received from the application 311. The authenticator information processing unit 343 verifies the signature 832 of the assertion information 830 by decrypting the signature 832 with the public key identified by the authentication information ID 831 and determining whether the decrypted signature matches the assertion challenge 811 included in the authentication parameters 810 generated in step S713. The public key is identified using the authenticator information management table. In a case where the verification is successful, in step S723, the token management unit 347 of the web service 341 issues a token and manages information about the token in the token management table. In step S724, the token management unit 347 of the web service 341 returns the token issued in step S723 to the application 311.

In step S725, the authenticator authentication control unit 315 transmits an item purchase request to the web service 341 using the token received in step S724.

In step S726, the token management unit 347 verifies the token provided to the request in step S725, and in a case where this verification is successful, purchase processing corresponding to the request is performed. In step S727, the web service 341 returns, to the application 311, a response indicating that the purchase processing is completed.

In step S728, the authenticator authentication control unit 315 of the web service 341 determines whether to notify the authentication result based on the capability information 541 included in the assertion extension area 812 of the authentication parameters 810 returned in step S714.

As in the authenticator registration, in a case where the authenticator authentication control unit 315 determines that the notification capability is “not supported” by the wearable terminal 101, the authenticator authentication control unit 315 calls the notification control unit 316. A notification indicating that the authentication processing and the purchase processing in step S726 have been completed is then provided to the user 401, in place of the processing of step S719.

For example, FIG. 9C illustrates a screen that is displayed in a case where step S728 is performed by the authenticator authentication control unit 315. As in the authenticator registration, a pattern of the notification in step S728 is not limited to any specific pattern because a different notification pattern, such as a UI display notification, an audio notification, and a vibration notification, is used depending on an apparatus that the client terminal 102 includes. In a case where the authenticator authentication control unit 315 determines in step S728 that the notification capability is “supported” by the wearable terminal 101, the notification of the completion of the authentication in FIG. 9C is unnecessary, and the screen changes to a screen illustrated in FIG. 9D.

As described above, according to the first exemplary embodiment, the authenticator 331 of the wearable terminal 101 includes the notification control unit 336 to provide notification to the user 401 so that the user 401 can recognize that biometric information has been input and authenticator registration and authentication processing has been performed. Further, a description has been described of a method with which the notification control unit 316 of the client terminal 102, as an alternate, provides a notification to the user 401 even in a case where the wearable terminal 101 does not include the notification control unit 336. With this system, even in a case where a wearable terminal that does not require a user to perform an operation for authentication is used as an authenticator, the user can recognize, at appropriate timings, that biometric information has been input by the user and the authenticator registration and authentication processing has been surely performed.

### Second Exemplary Embodiment

According to the first exemplary embodiment, the authenticator registration processing unit 332 and the biometric authentication processing unit 333 of the authenticator 331 are controlled to provide a notification to the user 401 simply by calling the notification control unit 336 after the operation in step S423 or the operation in step S718 is ended. However, the user 401 may wish to control whether to provide a notification or a notification pattern, depending on a service provided by the web service 341 used by the user 401.

For example, in a system that frequently requests authentication during the use of the service, the user may feel bothered in a case where the user receives a notification each time an authentication is completed. The user may wish to change a notification pattern for the same authentication processing based on an operation on the web service 341.

In view of the foregoing cases, control information about a notification is additionally storable in the extension area 515 of the registration parameters 510 during the authenticator registration or in the assertion extension area 812 of the authentication parameters 810 during the authentication. The control information is interpretable by the notification control unit 336 of the wearable terminal 101, and in steps S424 and S719, the notification control unit 336 determines whether to provide a notification based on a value of the control information. More specifically, the notification is controllable to be provided only in a case where the value of the control information indicates that notification is to be provided. Further, the notification pattern (details of message, light emitting diode (LED) lighting pattern) is changeable based on the value of the control information.

It is to be noted that in a case where the extension area 515 or the assertion extension area 812 does not include the control information, the processing according to the first exemplary embodiment may be performed.

The extension according to the present exemplary embodiment makes it possible to control the notification by the wearable terminal 101 from the web service 341.

### Third Exemplary Embodiment

According to the first exemplary embodiment, the notification control unit 336 provides a notification at a timing when the biometric authentication in the wearable terminal 101 as an external authentication unit is successful, for example, in steps S424 and S719.

In a notification method according to a third exemplary embodiment described below, a notification is provided based on completion of the processing of the web service 341. Differences between the present exemplary embodiment and the first and second exemplary embodiments will be described in detail below, while redundant description is omitted.

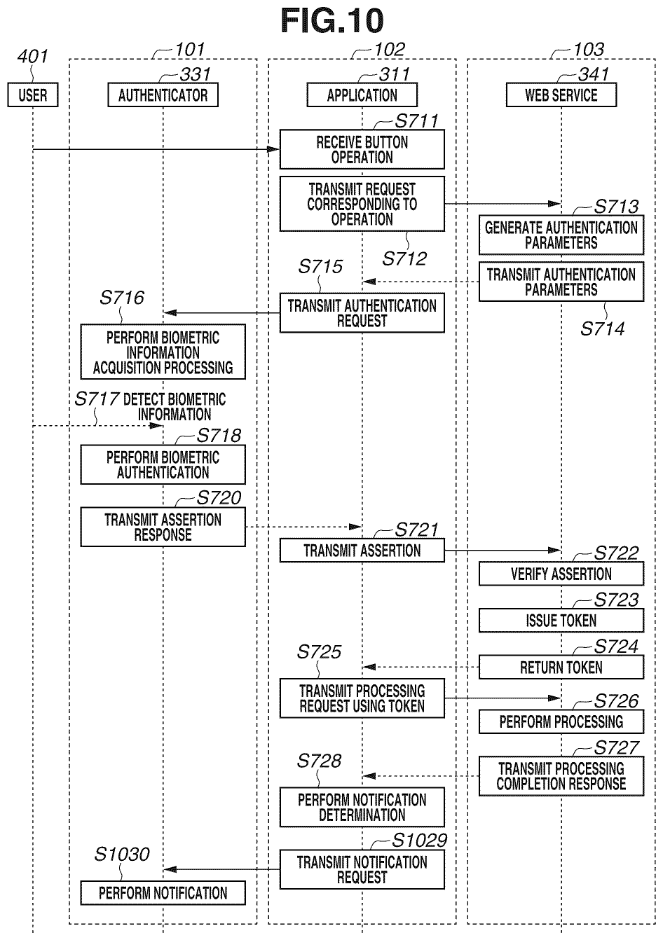

FIG. 10 is a sequence diagram that is different from the sequence during authentication according to the first exemplary embodiment in that the notification timing is changed. A difference is that the notification process in step S719 is omitted and the operations in steps S1029 and S1030 are added.

In step S728, whether the wearable terminal 101 has the notification capability and whether notification is to be provided are determined at the same time. If it is determined that notification with the wearable terminal 101 is to be provided, in step S1029, the authenticator authentication control unit 315 transmits a notification request to the authenticator 331.

In step S1030, the notification control unit 336 of the authenticator 331 having received the notification request performs notification control to indicate that the series of processing including the authentication processing has been completed. The notification control here may be a process similar to the notification process in step S719 or may be performed to provide a notification from which the completion of the processing is recognizable directly.

In the first and second exemplary embodiments, in a case where, for example, the client terminal 102 and the server system 103 fail to communicate with each other during the operation in step S426 or the operations in step S721 and the subsequent processes, the sequence illustrated in FIG. 4 or 7 is abnormally ended. Here, although the entire sequence is not ended normally, the notification control unit 336 of the wearable terminal 101 has ended up notifying the user 401 that the authentication is successful in step S424 or S719. This may cause the user 401 to misunderstand that the purchase processing is successful.

In contrast, the notification timing is set after the processing in the web service 341 is completed, in the present exemplary embodiment. This may make it possible to avoid such a misunderstanding.

In the present invention, it is possible to provide different notifications at the timing of step S719 according to the first exemplary embodiment and at the timing of step S1030 according to the third exemplary embodiment by combining first and third exemplary embodiments of the present invention, thus providing the successful authentication notification and the processing completion notification separately to the user.

### Other Exemplary Embodiments

The present invention encompasses apparatuses and systems as well as methods therefor, which include a combination of any of the above-described exemplary embodiments as appropriate.

The present invention is an apparatus or a system that executes one or more pieces of software (program) for realizing the functions of the exemplary embodiments described above. Further, methods for realizing the above-described exemplary embodiments that are executed by the apparatus or the system are also an aspect of the present invention. Further, the program is supplied to the system or the apparatus via a network or various storage mediums, and one or more computers (CPUs, micro-processing units (MPUs)) of the system or the apparatus read the program to one or more memories and execute the read program. Specifically, the program and various computer-readable storage mediums storing the program are also included as an aspect of the present invention. Further, the present invention can be realized also by a circuit (e.g., application-specific integrated circuit (ASIC)) for realizing the functions of the above-described exemplary embodiments.

The present invention is not limited to the above-described exemplary embodiments, and various changes and modifications are possible without departing from the spirit and scope of the present invention. Thus, the following claims are attached to disclose the scope of the present invention.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

The present invention provides a mechanism with which a notification associated with authentication processing is appropriately provided to a user even in a case where a wearable terminal is used as an authenticator.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An information processing apparatus configured to execute an application for controlling authentication processing using an external authenticator connected to the information processing apparatus, the information processing apparatus comprising:
a first transmission unit configured to transmit a request to a system configured to communicate via a network;
a first reception unit configured to receive verification data from the system;
a request unit configured to transmit an authentication request including the verification data to the external authenticator;
a second reception unit configured to receive, from the external authenticator, signature data generated by the external authenticator;
a second transmission unit configured to transmit the signature data to the system; and
a third reception unit configured to receive data based on a result of verification processing on the signature data using a public key registered in the system,
wherein the external authenticator is worn by a user of the information processing apparatus, and
wherein the external authenticator provides a notification to the user in response to at least one of a result of biometric authentication in response to the authentication request, and a request transmitted from the information processing apparatus to the external authenticator in response to the third reception unit receiving the data.

2. The information processing apparatus according to claim 1, further comprising a control unit configured to control a display for the user wearing the external authenticator in response to at least one of the result of the biometric authentication in response to the authentication request, and the third reception unit receiving the data.

3. The information processing apparatus according to claim 2, wherein, in a case where the external authenticator does not support a function for the notification, the control unit controls the display.

4. The information processing apparatus according to claim 1, wherein the notification to the user by the external authenticator is performed in accordance with control information regarding the notification that is included in the authentication request.

5. The information processing apparatus according to claim 1, wherein the external authenticator is any one of a smartwatch, an earphone, and a smart ring that are configured to perform biometric authentication even while being worn by the user.

6. A method for an information processing apparatus for controlling authentication processing using an external authenticator to be connected to the information processing apparatus, the method comprising:
transmitting, as first transmission, a request to a system configured to communicate via a network;
receiving, as first reception, verification data from the system;
transmitting an authentication request including the verification data to the external authenticator;
receiving, as second reception, signature data generated by the external authenticator from the external authenticator;
transmitting, as second transmission, the signature data to the system; and
receiving, as third reception, data based on a result of verification processing on the signature data using a public key registered in the system,
wherein the external authenticator is worn by a user of the information processing apparatus, and
wherein the external authenticator provides a notification to the user in response to at least one of a result of biometric authentication in response to the authentication request and, a request transmitted from the information processing apparatus to the external authenticator in response to the third reception receiving the data.

7. A non-transitory computer-readable storage medium storing a program for causing a computer to function as the units according to claim 1.

8. An authenticator configured to connect as an external authenticator to an information processing apparatus configured to execute an application for controlling authentication processing using the external authenticator, and configured to be worn by a user of the information processing apparatus, the authenticator comprising:
a detection unit configured to detect biometric information about the user in response to receiving an authentication request from the information processing apparatus;
an authentication unit configured to perform biometric authentication using the biometric information;
a generation unit configured to generate signature data using verification data included in the authentication request and a private key corresponding to the biometric information in a case where the biometric authentication is successful;
a transmission unit configured to transmit the signature data to the information processing apparatus; and
a notification unit,
wherein the notification unit provides a notification to the user in response to at least one of a result of the biometric authentication in response to the authentication request, and a request transmitted from the information processing apparatus to the external authenticator.

9. The authenticator according to claim 8, wherein the notification to the user by the authenticator is provided in accordance with control information regarding the notification that is included in the authentication request.

10. The authenticator according to claim 8, wherein the authenticator is any one of a smartwatch, an earphone, and a smart ring that are configured to perform the biometric authentication while being worn by the user.

11. The authenticator according to claim 8, wherein the notification is provided by sound or vibration.

12. A method for an authenticator configured to connect as an external authenticator to an information processing apparatus configured to execute an application for controlling authentication processing using the external authenticator, the authenticator being configured to be worn by a user of the information processing apparatus and including a notification unit, the method comprising:
detecting biometric information about the user in response to receiving an authentication request from the information processing apparatus;
performing biometric authentication using the biometric information;
generating signature data using data for verification included in the authentication request and a private key corresponding to the biometric information in a case where the biometric authentication is successful; and
transmitting the signature data to the information processing apparatus,
wherein the notification unit provides a notification to the user in response to at least one of a result of the biometric authentication in response to the authentication request, and a request transmitted from the information processing apparatus to the external authenticator.

13. A non-transitory computer-readable storage medium storing a program for causing a computer to function as the units according to claim 8.
